(19) United States
(12) Patent Application Publication
(10) Pub. No.: US 2006/0017776 A1
(43) Pub. Date: Jan. 26, 2006

(54) Increasing key combinations for inkjet cartridges

(76) Inventors: Charles Morton, Leander, TX (US); Christa Ferguson, Round Rock, TX (US); Donald Guthan, Round Rock, TX (US); Dustin Sorenson, Austin, TX (US)

Correspondence Address: HAMILTON & TERRILE, LLP, P.O. BOX 203518, AUSTIN, TX, 78720, US

(21) Appl. No.: 10/896,709

(22) Filed: Jul. 22, 2004

(51) Int. Cl. B41J 2/14

(52) U.S. Cl. 347/49

(57) ABSTRACT

A method for providing a plurality of key combinations for a printer consumable which includes providing a printer consumable with a multiple projection key module having a plurality of keys and configuring the plurality of keys within the key module to provide a printer consumable key combination. The printer consumable key combination uniquely identifies the printer consumable as a particular type of printer consumable.

### BACKGROUND OF THE INVENTION

1. Field of the Invention

The present invention relates to the field of printers and more particularly to inkjet cartridges which are used with printers.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems. One example of an information handling device is a printer.

Some known printers use printer consumables such as inkjet cartridges to present information onto a print media. Known inkjet cartridges have limited surface area for modifications. Additionally, different inkjet cartridge original equipment manufactures (OEMs) may use similar cartridges.

Known printer cartridges are keyed by extruding parts from certain surfaces. While effective, this is an inefficient method for generating keys. Also, this method is easily circumvented by removing the extrusion such as with clippers.

Accordingly it is desirable to provide a method for generating multiple hardware/mechanical keys using the limited area of the print cartridge. Additionally, it is desirable to provide a printer cartridge keying system with a large number of potential combinations to enble unique indentification of a large number of cartridges (e.g., photo, color, high-yield color, etc.) thus allowing a print cartridge supplier to uniquely identify a greater product range.

### SUMMARY OF THE INVENTION

In accordance with the present invention, a multiple projection configuration for keying inkjet cartridges is set forth. The multiple projection configuration enables a large number of combinations to be generated from a small structure. The keys mate with a receiving unit on a carrier having a complementary key configuration. Thus, a particular key configuration only fits similarly configured carriers.

The multiple projection configuration offers a solution that provides an efficient method for generating a higher number of keys per cartridge. The method for generating a higher number of keys on a cartridge in a space-efficient manner is difficult to disable and allows for a greater range of supported cartridges, as well as restrictions from certain StockKeeping Units (SKUs). The multiple projection configuration allows a greater selection of inkjet cartridges, and easily restricts certain cartridges to certain product lines.

In one embodiment, the invention relates to a method for providing a plurality of key combinations for a printer consumable which includes providing a printer consumable with a multiple projection key module having a plurality of keys and configuring the plurality of keys within the key module to provide a printer consumable key combination. The printer consumable key combination uniquely identifies the printer consumable as a particular type of printer consumable.

In another embodiment, the invention relates to a printer consumable having a plurality of key combinations which includes a multiple projection key module having a plurality of key locations. The plurality of keys is configured within the key module to provide a printer consumable key combination. The printer consumable key combination uniquely identifies the printer consumable as a particular type of printer consumable.

In another embodiment, the invention relates to an information handling system which includes a control system and a consumable coupled to the control system. The consumable includes a multiple projection key module having a plurality of key locations. The plurality of keys is configured within the key module to provide a consumable key combination. The consumable key combination uniquely identifies the consumable as a particular type of consumable to the control system.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an environment in which a printer is used.

FIG. 2 shows a perspective view of an inkjet cartridge.

FIG. 3 shows a perspective view of the interface with an inkjet cartridge having a multiple projection key.

FIG. 4 shows a perspective view of another interface with an inkjet cartridge having another multiple projection key.

### DETAILED DESCRIPTION

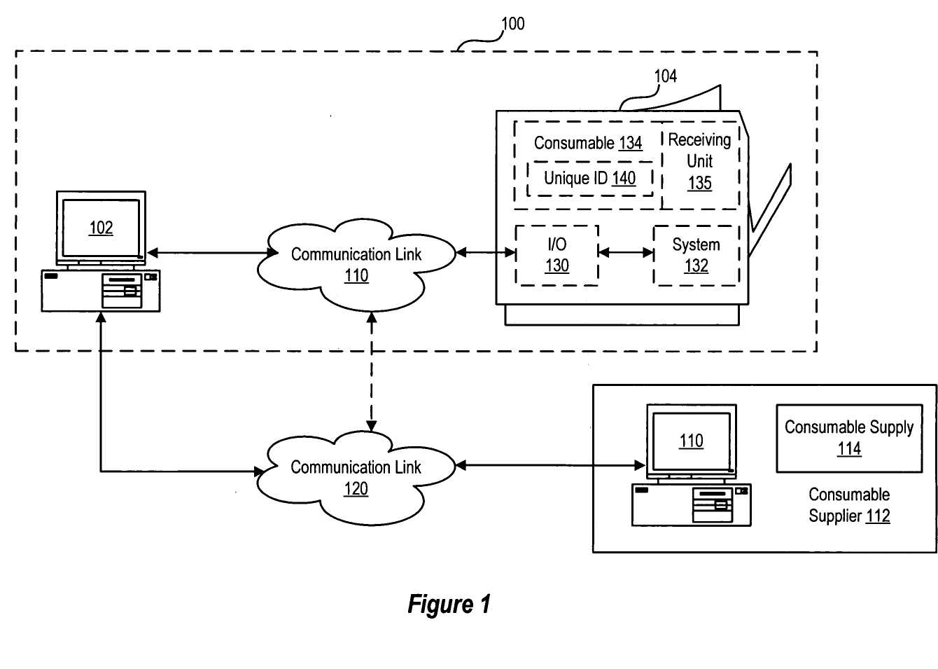

Referring to FIG. 1, a block diagram of an environment in which a printer is used is shown. The environment includes a computer system 102 and a printer 104, coupled via a communication link 110. The communication link 110 might be a printer cable, a network connection or any other link which information is communicated with the printer 104.

The computer system 102 is also connected to another computer system (e.g., a vendor computer system) 110 via a second communication link 120. The second communication link 120 may be a telephone system or some other type of network, such as the Internet. In one embodiment, computer system 110 is owned and operated by a printer consumable supplier 112. In this example, the printer consumable supplier 112 provides printer consumables for use with the printer 104 from a supply 114 of printer consumables. The printer 104 may be directly coupled to the second communication link 120, in which case communication may occur between the printer and anything coupled to the second communication link 120.

The printer 104 includes an input output (I/O) port 130, a control system 132, at least one printer consumable 134 and a receiving unit 135. The I/O port 130 facilitates communications between the printer 104 and other devices connected to the communications link 110. The control system 132 provides the printer 104 with certain control functionality. The control system 132 includes a processor and memory coupled to the processor. The print cartridge ordering system may be stored on either the memory of the printer or within the memory of the computer system 102.

The printer consumable 134 represents any component in the printer 104 that is subject to depletion through use of the printer 104. For example, the printer consumable 134 may be a toner cartridge or an inkjet cartridge, etc. The printer consumable supplier maintains a supply 114 of replacement printer consumables 134.

The printer consumable 134 includes a unique printer consumable identification module 140. The unique printer consumable identification module 140 includes a multiple projection configuration module that mates with a complementary portion of the receiving unit 135 of the printer 104. The multiple projection configuration module 140 provides an efficient method for generating a relatively high number of keys per cartridge. The multiple projection configuration module 140 enables generating a higher number of keys on a printer consumable, such as an inkjet cartridge, in a space-efficient manner. The multiple projection configuration module 140 is difficult to disable and allows for a greater range of supported cartridges, as well as restrictions from certain StockKeeping Units (SKUs). The multiple projection configuration module 140 enables a greater selection of inkjet cartridges, and easily restricts certain cartridges to certain product lines.

The computer system 102 generates a document in an electronic form and transmits the document (in the form of a print job) to the printer 104. The printer 104 receives the print job via the I/O port 130 and prints the document. Each time the printer 104 prints a document, the printer 104 transmits a pre-defined message to the computer 102.

It may be determined that the consumable 134 should be replaced when certain criteria are met. For example, it is assumed that the consumable 134 should be replaced each time the printer 104 prints “n” pages. When this event occurs, the control system 132 sets a consumable replacement indicator.

The status of the consumable replacement indicator may be determined by the computer 102. This is accomplished by the computer 102 transmitting a pre-defined query to the printer 104. The printer 104 responds to the query by generating a response indicating whether the consumable replacement indicator is set.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

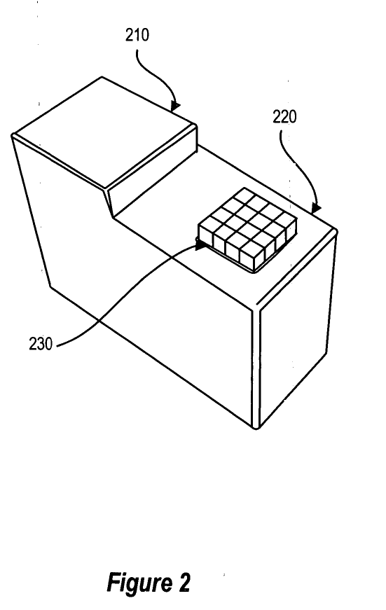

Referring to FIG. 2, a perspective view of an inkjet cartridge is shown. More specifically, the inkjet cartridge 210 includes a multiple projection key module 220. The multiple projection key module 220 enables keying inkjet cartridges. The multiple projection key module 220 enables a large number of combinations to be generated from a small structure.

More specifically, the multiple projection key module 220 includes a plurality of keys 230. The plurality of keys are arranged in a shape, such as for example, a square or a rectangle, where each of the keys are positioned contiguous to one another. In one embodiment, the multiple projection key module 220 includes a square of four keys by four keys, to provide a total of sixteen keys. Each of the sixteen keys may be individually omitted from the multiple projection key module 220 to uniquely identify a particular type of inkjet cartridge. Also, the sixteen keys may be combinatorially omitted from the multiple projection key module 220. Accordingly, a multiple projection key module having sixteen keys can provide a potential of 2¹⁶ different potential key combinations.

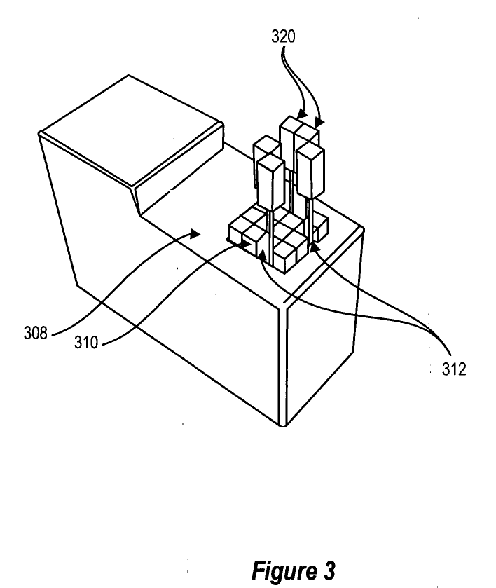

Referring to FIG. 3, a perspective view of the interface with an inkjet cartridge having a multiple projection key 308 is shown. More specifically, the multiple projection key 310 includes ten keys 310 as well as five key locations 312 in which the keys were omitted. The corresponding printer key 320 includes five projections 322 which complement the five omitted key locations 312.

The keys 310 and omitted keys locations 312 within the multiple projection configuration module 308 mate with complementary projections 322 located on a receiving unit on a ink jet carrier (not shown) having a complementary key configuration. Thus, a particular key configuration only fits similarly configured carriers.

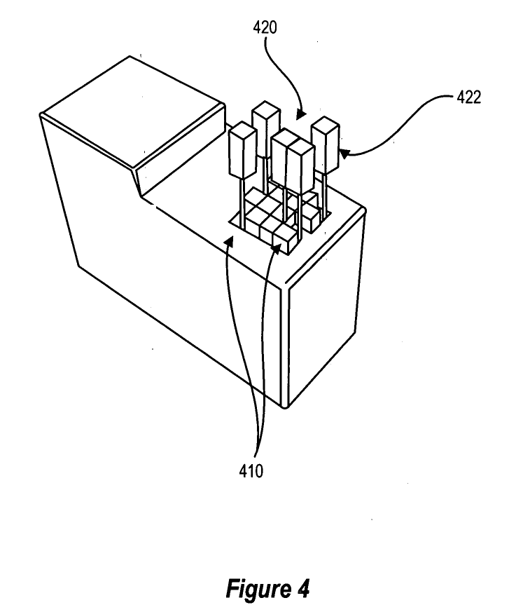

Referring to FIG. 4, a perspective view of another interface with an inkjet cartridge having another multiple projection key is shown. More specifically, the multiple projection key 410 includes ten keys 410 as well as five key locations 412 in which the keys were omitted. The corresponding printer key 420 includes five projections 422 which complement the five omitted key locations 412.

The keys 410 and omitted keys locations 412 within the multiple projection configuration module 408 mate with complementary projections 422 located on a receiving unit on a ink jet carrier (not shown) having a complementary key configuration. A particular key configuration only fits similarly configured carriers.

Accordingly, while the configuration module 308 and the configuration module 408 each include five omitted key locations, one module would not mate with the carrier of the other module.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also for example, it will be appreciated that other types of printer consumables in addition to inkjet cartridges may include multiple projection key modules.

Also for example, the plurality of keys of the multiple projection key module may be arranged in any shape as desired for a particular purpose. Thus, if a rectangle, triangle or other geometric shape were desired, the plurality of keys could be arranged in the other geometric shape. The keys within the multiple projection key could then be configured to provide the desired shape of the multiple projection key module.

Also for example, the multiple projection key module may have any number of keys as desired for a particular purpose. Thus, if more key combinations were desired, a multiple projection key module having more keys could be provided. If fewer key combinations were desired, a multiple projection key module having fewer keys could be provided.

Consequently, the invention is intended to be limited only by the spirit and scope of the appended claims, giving full cognizance to equivalents in all respects.

What is claimed is:

1. A method for providing a plurality of key combinations for a printer consumable comprising:
providing a printer consumable with a multiple projection key module having a plurality of keys;
configuring the plurality of keys within the key module to provide a printer consumable key combination, the printer consumable key combination uniquely identifying the printer consumable as a particular type of printer consumable.

2. The method of claim 1 wherein:
the configuring includes omitting keys from particular key locations.

3. The method of claim 2 wherein:
a printer mates with the multiple projection key module such that the printer includes projections corresponding to the particular key locations from which keys are omitted.

4. The method of claim 1 wherein:
the configuring includes providing keys in particular key locations.

5. The method of claim 4 wherein:
a printer mates with the multiple projection key module such that the printer omits projections from key locations complementing the particular key locations which include keys.

6. The method of claim 1 wherein:
the configuring includes omitting keys from particular key locations and providing keys in particular key locations.
a printer mates with the multiple projection key module such that the printer includes projections corresponding to the particular key locations from which keys are omitted and omits projections from key locations complementing the particular key locations which include keys.

7. A printer consumable having a plurality of key combinations comprising:
a multiple projection key module having a plurality of key locations, the plurality of keys being configured within the key module to provide a printer consumable key combination, the printer consumable key combination uniquely identifying the printer consumable as a particular type of printer consumable.

8. The printer consumable of claim 7 wherein:
the printer consumable key combination includes omitted keys from particular key locations.

9. The printer consumable of claim 8 wherein:
a printer mates with the multiple projection key module such that the printer includes projections corresponding to the particular key locations from which keys are omitted.

10. The printer consumable of claim 7 wherein:
the printer consumable key combination includes keys in particular key locations.

11. The printer consumable of claim 10 wherein:
a printer mates with the multiple projection key module such that the printer omits projections from key locations complementing the particular key locations which include keys.

12. The printer consumable of claim 7 wherein:
the printer consumable key combination includes omitted keys from particular key locations and keys in particular key locations.
a printer mates with the multiple projection key module such that the printer includes projections corresponding to the particular key locations from which keys are omitted and omits projections from key locations complementing the particular key locations which include keys.

13. The printer consumable of claim 7 wherein:
the printer consumable includes an ink jet cartridge.

14. An information handling system comprising:
a control system;
a consumable coupled to the control system, the consumable including a multiple projection key module having a plurality of key locations, the plurality of keys being configured within the key module to provide a consumable key combination, the consumable key combination uniquely identifying the consumable as a particular type of consumable to the control system.

15. The information handling system of claim 14 wherein:
the consumable key combination includes omitted keys from particular key locations.

16. The information handling system of claim 15 further comprising:
a receiving unit; and wherein,
the receiving unit mates with the multiple projection key module such that the receiving unit includes projections corresponding to the particular key locations from which keys are omitted.

17. The information handling system of claim 14 wherein:
the consumable key combination includes keys in particular key locations.

18. The information handling system of claim 17 further comprising:
a receiving unit; and wherein,
the receiving unit mates with the multiple projection key module such that the receiving unit omits projections from key locations complementing the particular key locations which include keys.

19. The information handling system of claim 14 further comprising:
a receiving unit; and wherein
the consumable key combination includes omitted keys from particular key locations and keys in particular key locations.
the receiving unit with the multiple projection key module such that the receiving unit includes projections corresponding to the particular key locations from which keys are omitted and omits projections from key locations complementing the particular key locations which include keys.

20. The information handling system of claim 14 wherein:
the consumable includes a printer consumable.

21. The information handling system of claim 14 wherein:
the information handling system includes a printer.
